(19) United States
(12) Patent Application Publication
(10) Pub. No.: US 2003/0162536 A1
(43) Pub. Date: Aug. 28, 2003

(54) Method and system for cooperative parking space discovery and transfer

(76) Inventor: Joseph W. Panico, Hoboken, NJ (US)

Correspondence Address: Joseph W. Panico, 609 Jefferson, Unit 5c, Hoboken, NJ, 07030, US

(21) Appl. No.: 10/374,471

(22) Filed: Feb. 26, 2003

Related U.S. Application Data
(60) Provisional application No. 60/359,869, filed on Feb. 27, 2002.

(51) Int. Cl. H04Q 7/20

(52) U.S. Cl. 455/422; 455/403

(57) ABSTRACT

A method that matches a vehicle about to vacate a parking space with a vehicle searching for parking in that same area, and a system to support this method. The vehicle occupying the parking space sends a “space offered” message, via a wireless mobile communications network, to a central control system. The vehicle searching for a parking space sends a “space requested” message, via a wireless mobile communications network, to the same central control system. The central control system matches a parking space request with a compatible parking space offer. The central control system then dispatches a message to the offering vehicle instructing it to wait, and also dispatches a message to the requesting vehicle directing it to the offered space. When the requesting vehicle arrives at the designated parking space, the offering vehicle vacates the space and the requesting vehicle takes its place.

### CROSS-REFERENCE TO RELATED APPLICATIONS

This application is entitled to the benefit of Provisional Patent Application Ser. No. 60/359,869 filed Feb. 27, 2002.

### FIELD OF INVENTION

This invention relates to a method of allowing a vehicle that occupies a parking space to transfer that space to a vehicle that is seeking a parking space, as well as a device for performing the method.

### BACKGROUND

Vehicle drivers often spend considerable amounts of time searching for unoccupied parking spaces when they arrive in highly congested areas. A number of schemes have been proposed to aide the driver in locating and securing one of these unoccupied spaces. However, each of the known schemes has some of the following problems:

(a) It requires sensors at or near the parking spaces to detect occupancy status;

(b) While notifying an individual subscriber of the availability of a non-gated parking space, the system cannot guarantee that the space will still be available by the time that subscriber arrives at the space;

(c) While notifying an individual subscriber of the availability of a non-gated parking space, the system cannot guarantee that the subscribing vehicle will physically fit in the space;

(d) The scheme requires an accurate centralized database of parking space locations and attributes;

(e) The scheme requires that subscribers purchase specialized single-purpose devices in order to participate in the system.

There is a need for a system that is not subject to any of the above limitations, because each of these limitations significantly decreases the attractiveness of a solution. For instance, a system that relies on sensors at non-enclosed parking spaces is very expensive, not just in initial purchase and deployment, but also in long-term maintenance and protection from vandalism. A system that can notify a subscriber of the current availability of non-gated parking spaces, but cannot guarantee that a parking space will be made available to the subscriber at the time of arrival, is of limited use. Likewise, a system that can notify a subscriber of the availability of non-gated parking spaces, but cannot guarantee that the subscriber's vehicle will fit in one of these spaces, is not very satisfying for consumers.

The need for a centralized database is particularly vexing. It is difficult and expensive to maintain an accurate database of parking space locations and attributes for a non-enclosed environment. A system can attempt to build and maintain such a central database automatically by compiling the spatial coordinates of parked vehicles; coordinates submitted by the vehicles to the central system via a wireless mobile network. But this approach is bound to produce incomplete and unreliable results. The results will be incomplete because not all vehicles in a given zone participate in the system, and therefore not all spaces will be visited by a participating vehicle. The results will be unreliable because of the difficulty of automatically determining when a vehicle is parked in a legitimate generally available parking space. The basic assumption is that a vehicle stationary phase corresponds to parking. But a vehicle stationary phase could result from breakdown or illegal parking. The vehicle might make a long duration non-parking stop to wait for some event. The vehicle may be parked in a special status space, reserved or private parking, which will not be legally available to others seeking a space. It is particularly difficult to apply this technique to legitimate parking space that is not demarcated, such as “non-striped” and non-metered on-street parking. Because of the unconstrained nature of such space, the configuration of individual parking spaces can change on an hourly basis. In order to surmount all of the problems associated with automatically generating a database, the system could instead require manual compilation of the database. In this case, field workers would have to visit each parking space in order to record its attributes in the central database, and would have to periodically revisit each parking space to ensure that it has not changed. Performing this task over a large number of parking spaces would be prohibitively expensive.

Finally, a system that requires subscribers to have specialized hardware is unnecessarily expensive and burdensome. Increasingly, people already carry many general-purpose digital devices with which they are already familiar, such as digital mobile phones, PDAs, and handheld computers. Each new device that a user must purchase and familiarize themselves with is a burden. Further, if a dedicated “parking aide” device is permanently mounted in a vehicle; then it is not available for use in other vehicles.

### SUMMARY

An embodiment of the present invention relates to a method and device that allow vehicle drivers who intend to vacate parking spaces to be matched with nearby drivers seeking parking spaces, and that effect the transfer of the parking space from one vehicle to the other. More particularly, one embodiment of the present invention includes a method and system for a parking space occupant using a mobile wireless communications device to send a “space offered” message to a central control system. The space seeker, also using a mobile wireless communications device, sends a “space requested” message to the same central system. The central control system then matches a space offer with a compatible space request, instructs the space occupant to wait, and sends navigational instructions that direct the space seeker to the space. When the seeker arrives at the location of the space, the central system instructs both vehicles to transfer the space, and the transaction is recorded for billing purposes.

The term “parking space” refers to any type of a parking space, whether it be public, private, on-street, in a garage, in a parking lot, metered or non-metered. The term “gated parking space” refers to a parking space ingress to which is somehow physically limited, such as in a barricaded parking garage or lot. The term “non-gated parking space” refers to a parking space that is not “gated”. The term “demarcated parking space” refers to an individual parking space for which the boundaries are explicitly drawn, such as through the use of painted lines on the pavement (known as “striping”). The term “non-demarcated parking space” refers to an individual parking space that is not demarcated, as in the case of residential on-street parking where there are no meters, no stripes, and only signage to indicate the location of an area of unconstrained parking space.

Objects and Advantages

Accordingly, it is an object of the present invention to provide a system for locating an available parking space that does not rely on any specialized sensors at or near the parking space to detect the occupancy status.

It is a further object of the present invention to provide a system that can notify an individual subscriber of the availability of a non-gated space and guarantee that the space will still be available by the time that subscriber arrives at the space.

It is a further object of the present invention to provide a system that can notify an individual subscriber of the availability of a compatible parking space and guarantee that the subscribing vehicle will physically fit in that parking space.

It is a further object of the present invention to provide a system that can reliably detect available parking space locations without the need to establish and maintain a database of historical parking space attributes.

It is a further object of the present invention to provide a parking space detection and transfer system that does not require drivers to possess single-purpose specialized hardware in order to participate in the system, but instead allows them to employ multi-purpose wireless mobile communications devices such as cell-phones, PDAs and on-board navigational systems.

Further objects and advantages are to provide a parking space detection and transfer system that is simple and convenient to use, simple and inexpensive for the system manager to set up and maintain, and can provide available parking spaces to subscribers with a high degree of confidence.

Further objects and advantages will become apparent from a consideration of the ensuing description and drawings.

### DRAWING FIGURES

FIG. 1 is an illustration of a parking space discovery and transfer system in accordance with an embodiment of the present invention;

FIG. 2 is a block diagram of a parking space discovery and transfer central control system and a mobile user unit that communicates with it, in accordance with the FIG. 1 embodiment of the present invention; and

FIG. 3 is a flow chart of a method for parking space discovery and transfer, in accordance with the FIG. 1 embodiment of the present invention.

### DESCRIPTION

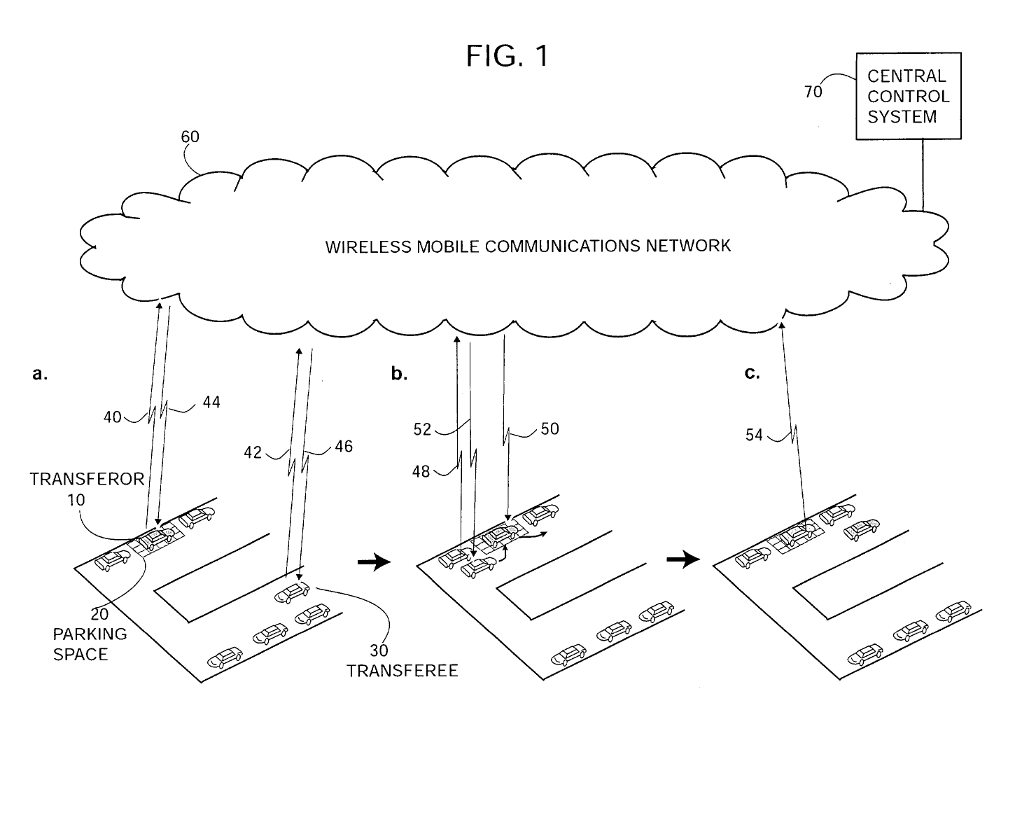

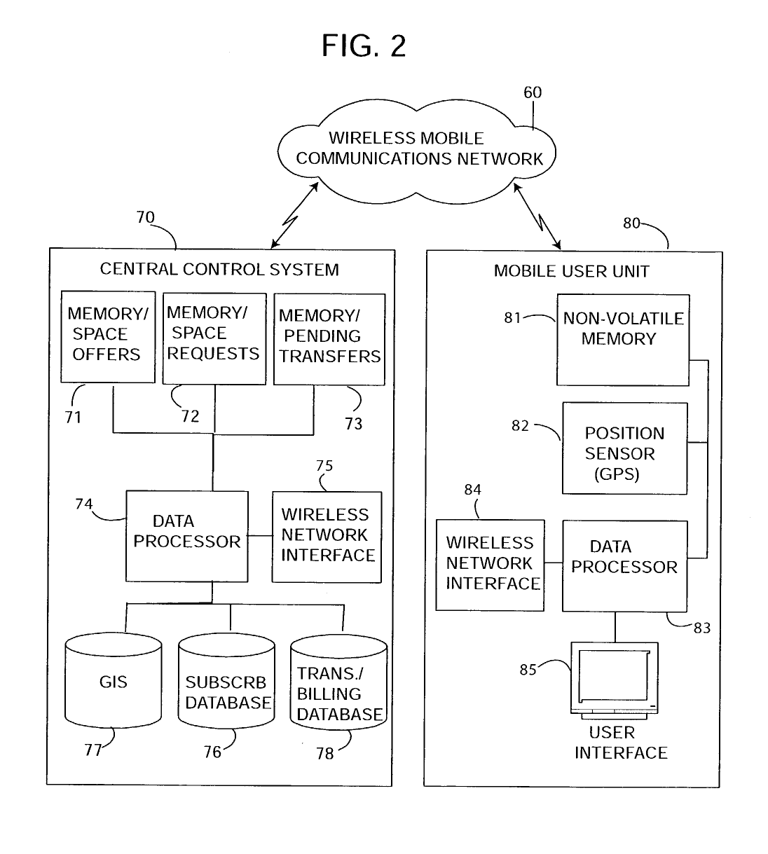

In one embodiment of the present invention, a method and system for the cooperative discovery and transfer of parking space is illustrated in FIGS. 1 and 2. FIG. 1 shows a sequence of three scenes in which there is a network of streets that offer parking spaces, and two vehicles 10 and 30 that are subscribers to a parking space transfer service based on the current invention. A vehicle 10 starts parked in a legitimate parking space 20 while vehicle 30 is searching for a legitimate parking space. It should be appreciated that while parking space 20 is depicted in FIG. 1 as a grid of lines on the pavement, for the sake of clarity, in practice it may be “non-demarcated”.

Both vehicles 10 and 30 carry a mobile user unit 80, shown in FIG. 2, for interacting with the parking space transfer service. Unit 80 contains a non-volatile memory 81 that is used to persistently store information that describes the subscriber. This information can include a token that can uniquely identify the subscriber to the central system. This information might also include the geometry (length and width), make, model, year and color of the subscribing vehicle. Unit 80 also contains a position sensor 82 that allows it to determine the geographic location of the unit with a high degree of precision. In one embodiment, sensor 82 is a GPS (Global Positioning System) receiver that is part of the satellite based GPS. In another embodiment, sensor 82 is a receiver for some other kind of satellite based positioning system that operates on the same principle as GPS. In yet another embodiment, sensor 82 is a position sensor that operates on some other principle, e.g., triangulation of a wireless telephone signal. The invention is not limited by the type of sensor so that other currently known or hereinafter discovered sensors are contemplated as within the scope of this invention.

Unit 80 also includes a wireless network interface 84 that allows it to communicate with the central control system 70 through a wireless communications network 60. It should be appreciated that network 60 could be any type of wireless network that is capable of communicating digital messages to mobile users, which includes: cellular telephone networks, satellite based digital communications networks, General Packet Radio Service (GPRS) networks, a network that provides Internet Protocol (IP) networking over a wireless transport, as well as others currently known or hereinafter discovered. Unit 80 also presents to the driver a user interface 85, through which the driver interacts with the unit. Unit 80 also contains a data processor 83 that controls and coordinates elements 81, 82, 84, 85. It should be appreciated that mobile user unit 80 could be any type of device which contains elements 81-85, which includes: wireless handheld computers, Personal Digital Assistants (PDAs), digital cellular telephones, on-board vehicular navigation systems, special purpose devices manufactured specifically to participate in this parking space discovery and transfer system, as well as others currently known or hereinafter discovered. It should be noted that in one embodiment of this invention all of elements 81-85 reside in a single device so that whatever mobile user device is used be equipped with a location sensor.

In FIG. 1, messages are exchanged between a subscribing vehicle 10 or 30 and the central control system 70. Messages are communicated from a mobile user unit 80 to the central control system, or from the central control system to a user unit, over wireless network 60. Any message sent from a subscribing vehicle to the control system can contain the unique identifying token, stored in memory 81, for that subscriber. This can identify the subscriber to a control system.

FIG. 1a shows a “space offered” message 40 sent from vehicle 10. Message 40 can indicate that space 20 is about to be vacated and should be offered to a nearby subscriber. Message 40 can contain the position of the mobile user unit, and by extension the parking space, as reported by sensor 82. This message may contain any other additional information stored in memory 81 that will facilitate a parking space transfer, such as the geometry, make, model, year and color of the subscribing vehicle. This message may also contain any other additional information provided by the driver through interface 85 that will facilitate a parking space transfer, such as how long the driver is willing to wait for a transferee to show up, how much money or credit the driver wants in order to wait for a transferee, information describing the parking space, such as the presence and cost of parking meters, etc.

FIG. 1a also shows a “space requested” message 42 sent from vehicle 30. Message 42 can contain the position of vehicle 30 as reported by sensor 82. This message may contain any other additional information stored in memory 81 that will facilitate a parking space transfer, such as the geometry, make, model, year and color of the subscribing vehicle. This message may also contain any other additional information provided by the driver such as how far the driver is willing to travel for a parking space, how much money the driver is willing to spend to have a parking space transferred to him, etc.

FIG. 1a also illustrates instructional messages from the control system to the subscribing vehicles. A “wait for transferee” message 44, communicated from the control system to the vehicle 10, signals that a compatible subscriber, vehicle 30, has been found to take space 20 and that vehicle 10 should wait in the parking space for the transferee to arrive. Message 44 can contain the make, model, year, and color of vehicle 30, so that the driver of vehicle 10 can identify the transferee vehicle when it arrives. Message 44 can also contain an estimate of how long it will take the transferee to arrive at the parking space. A “drive to space message” message 46, communicated from the central control system to vehicle 30, signals that a compatible parking space 20 has been found and that vehicle 30 should proceed to that parking space. Message 46 can also contain the make, model, year and color of the transferor vehicle 10 so that the driver of vehicle 30 can identify the transferor. In one embodiment, message 46 can also contain a complete description of a driving route from the present position of vehicle 30 to the position of space 20. In another embodiment, message 46 can contain the geo coordinates of space 20 rather than directions to it. In this case, the mobile user unit itself can be responsible for translating these coordinates into driving directions that can be presented to the driver.

FIG. 1b shows an “arrived at space” message 48 sent from a transferee vehicle to the control system. This message signals to the control system that transferee 30 has arrived at parking space 20 and that the transfer can begin. This message may contain the position of vehicle 30, which could be used by a control system to verify the accuracy of the message. FIG. 1b also shows an “evacuate space” message 50 sent from a control system to a transferor 10. The “evacuate space” message instructs the transferor that a transferee vehicle is in position to enter the space and the transferor vehicle should exit the space. Also in FIG. 1b is a “park message” 52 that instructs the transferee to occupy parking space 20.

FIG. 1c shows a “parked” message 54 sent from a transferee vehicle to the control system. This message signals to the control system that transferee 30 has successfully occupied parking space 20. This message may contain the position of the vehicle, which could be used by a control system to verify the accuracy of the message. It should be appreciated that the set of messages 40-54 is merely illustrative of the types of messages that could be employed in this invention. This list is not exclusive nor is it necessarily required. In one embodiment, messages 40-46 are used and any of the other messages may be omitted. Yet other messages, which are not shown, may be added. One such message, sent from a transferee, informs the central system that the transferee has found a parking space independent of the embodiment of the present invention, and that any space request associated with the transferee should be canceled. Another message could be from the central system to inform a transferor as to the progress of a transferee towards the parking space.

All messages between subscribing vehicles and a control system 70 can be transmitted through a network interface 75, in FIG. 2. A data processor 74 can process incoming messages and compile outgoing messages. Data processor 74 can store received “space offers” in memory 71 and received “space requests” in memory 72. Data processor 74 will also be capable of running an algorithm that matches “space offers” with “space requests” to begin a transfer. Data processor 74 can also manipulate memory 73 to update and monitor the data associated with pending, or “in process”, transfers. Data processor 74 can also access databases 76-78. A database of subscriber information 76 can allow the control system to validate any incoming message and correlate that message with a particular subscriber and perhaps vehicle. Database 76 can contain a record for each subscriber to the parking space transfer system. A subscriber record can contain a persistent unique identifier for the subscriber that corresponds to the identifier stored in mobile user unit for that subscriber. A subscriber record can also contain any information needed to link it to a billing account in “billing/transaction” database 78. A subscriber record may also contain any other information that would facilitate parking space transfer, such as the make, model, year, color and geometry of the subscribing vehicle.

In one embodiment, control system 70 includes a Geographic Information System (GIS) 77. This system can be used to calculate the distance between a transferor and a potential transferee. The distance between the two vehicles is used in the matching algorithm to determine if the potential transferee is close enough to the putative transferor to match the space offer. A GIS can also be used to compile street level driving directions to a parking space based on the geo coordinates of the transferor and transferee. A GIS can also be used by the control system to calculate estimates of how long it will take a transferee to reach a transferor.

In one embodiment, control system 70 also includes a transaction and billing database 78. This database can include an account record for each subscriber. That account record can contain information that allows the subscriber to be billed for participation in the service, such as subscriber name, address and credit card number. That account record can also store a persistently history of all parking space transfers that the subscriber has participated in. That account record can also track financial debits and credits to reflect parking space transfers in which the subscriber participated.

It should be appreciated that control system 70 need not be a single device. In a one embodiment, control system 70 can be a federation of cooperating devices networked together through a data communications protocol such as TCP/IP. For instance, wireless network interface 75 could be a dedicated networked wireless gateway between a TCP/IP LAN and the network 60. Data processor 74 and memories 71-73 could be a single networked computer server or a collection of load-sharing computer servers. Subscriber database 76 could be located in the same machine with elements 71-74 or may be a dedicated database server. The GIS system 77 and transaction/billing database 78 could be part of the same machine as 74, or dedicated servers that are networked to 74, or they could be third party data services that are provided on an as-needed basis over a shared network.

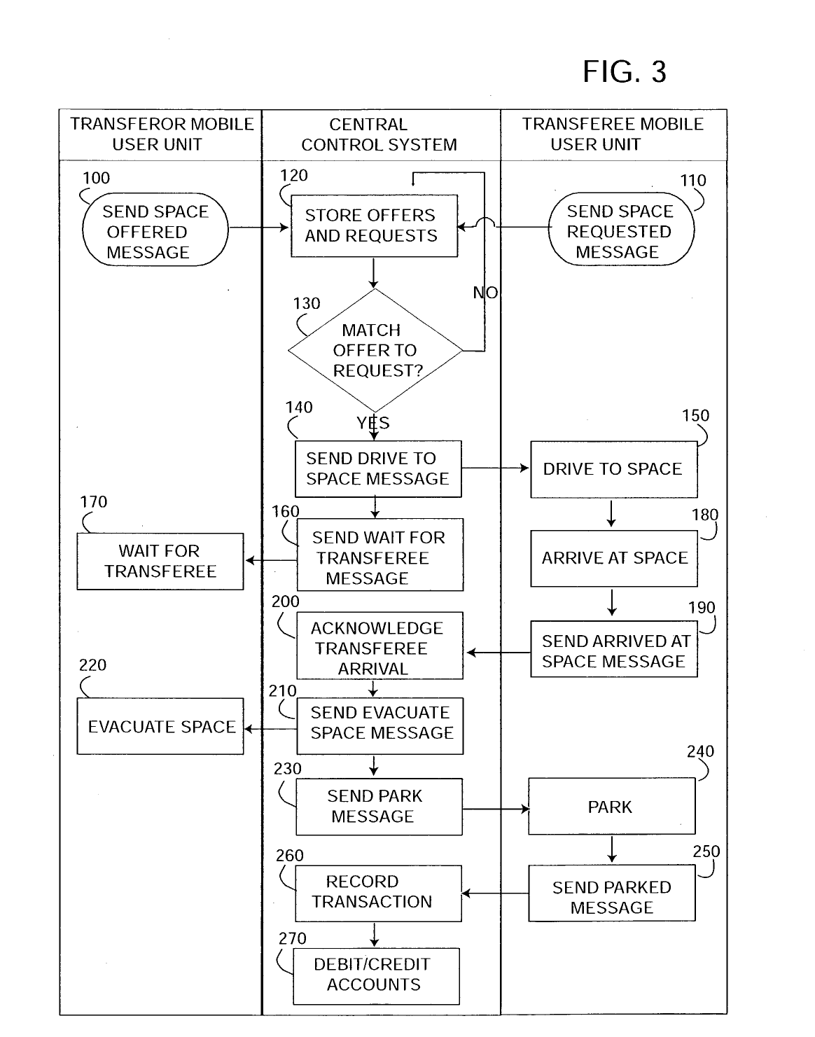

Operation of the parking space discovery and transfer system will now be described in connection with FIG. 3. When the driver of vehicle 10 decides to evacuate parking space 20 he may also decide to offer that space for transfer to another subscriber. The driver can offer the space for transfer by using a mobile user unit 80, which is carried in the vehicle, to send a “space offered” message 40 to the central system (100). That message, explicitly or implicitly, can indicate how long the driver is willing to wait for a transferee to appear and what remuneration (credit) the driver expects in order to wait for the transferee. At a nearby, though not identical, point in time the driver of vehicle 30 is hoping to acquire a parking space in the general vicinity of 20. That driver can use unit 80 to send a “space requested” message 42 to the central system (110). The “space requested” message can indicate, explicitly or implicitly, how far the driver is willing to travel, from his current location, to the parking space and how long the driver is willing to wait for an answer. The message can also indicate how much the driver is willing to pay for a parking space, in dollars or some other credits employed by the discovery and transfer system.

“Space offered” and “space requested” messages travel over wireless network 60 to arrive at the central control system through wireless network interface 75. At the central control system, data processor 74 can place the information encapsulated in messages 40 and 42 in memories 71 and 72 respectively (120). With the arrival of each new offer or request, data processor 74 can attempt to find a compatible match for the offer or request (130). A compatible match satisfies the time, distance, financial and physical (parking space geometry) requirements of both parties. The advantage of employing vehicular geometry is based on the following: if vehicle 10 fits in parking space 20 and vehicle 30 is of size less than or equal to vehicle 10, then vehicle 30 is guaranteed to fit in parking space 20. Otherwise, there is no guarantee that a successful transfer can be effected unless the transferor has manually included the geometry of the parking space itself in the “space offered” message. It should be appreciated that, in one embodiment, the central system matches an offer only with a single request, ensuring that the transferee does not have to compete for the space after a match is achieved.

Many different matching strategies could possibly be employed by the control system. A subscription service based on the current invention would choose one of these strategies according to the detailed business model. In one embodiment, all subscribers can pay a flat periodically recurring fee for participation in the system. A subscriber could consume, act as a transferee for, a fixed number of spaces for that flat fee. Beyond that number the subscriber can pay a fixed fee for each space consumed. Subscribers would be motivated to act as a transferor through incentives in the form of credits. Each transaction in which the subscriber is a transferor would produce a credit towards future consumption. To support this model, the matching mechanism could be based on a simple “first come first serve”. The first “space request” that is compatible with a “space offer”, that is where the requesting driver is within a proscribed distance of the offered space, matches.

In an alternative embodiment, the debits and credits for participating in a transfer are not fixed. Here, each “space offer” initiates a micro-auction. Each “space offered” message from vehicle 10 includes a price the driver expects to be paid in order to evacuate the parking space. Each “space requested” message from vehicle 30 includes a price that driver is willing to pay for a space; that message acts as a bid. The matching algorithm will attempt to match an offer price with a bid price. In the case where the offer is higher than the bid, the central system can transmit this information to the drivers involved and allow them to submit new offers and bids in an effort to converge the prices. A match is achieved when the prices converge.

In one embodiment, the “space offers” and “space requests” can have expirations associated with them, i.e., a specification of how long the offers or requests are good for. In the case where an offer or request is made that is not satisfied within the proscribed time period, the driver can be notified and the offer or request is removed from memory.

When a match is achieved, the central system can send a “drive to space” message 46 to the transferee (140). This message instructs the driver of vehicle 30 to drive to space 20, and includes instructions for doing so. The “transferee user unit” receives the “drive to space” message and directs the driver to parking space 20 (150). The user unit may have received from the control system complete street level navigational directions, derived from the GIS 77, which will guide the driver to the parking space. Or the user unit may have received only coordinates from the control system and will translates those coordinates into driving directions with the aid of some other GIS. Upon a match, the control system can also send a “wait for transferee” message 44 to the transferor vehicle (160). The “transferor user unit” receives this message and displays it to the driver (170). This message gives the transferor an indication of how long it will take for the transferee to arrive, and possibly a description of the transferee vehicle which will allow the transferor to identify it.

When the transferee arrives at space 20 (180), the driver may report this to the control system through the mobile user unit by sending an “arrived at space” message (190). Alternatively, the central control system might continually monitor the position of the transferee vehicle, as reported by position sensor 82, and automatically detect when the transferee has arrived at the parking space. In either case, the central control system acknowledges that the transferee has arrived at the space (200).

The central system can now send an “evacuate space” message 50 to the transferor (210) and a “park” message 52 to the transferee (230). In response to these messages, the user unit of the transferor can instruct the driver to evacuate the space (220) and the user unit of the transferee can instruct the driver to park (240). Once the transferee has occupied the space, that user unit can send a “parked” message 54 to the central system (250). Once the central system has detected that the transferee is parked, it will then record the transaction in database 78 (260) and debit or credit the appropriate accounts (270) according to the precise business model.

I claim:

1. A method for transferring a parking space from a first vehicle, the transferor, to a second vehicle, the transferee, comprising the steps of:
(a) transmitting a message from said transferor, via a wireless communications network, to a central control system that said parking space, currently occupied by said transferor, is offered for transfer;
(b) transmitting a message from said transferee, via a wireless communications network, to said central control system that said transferee requests a parking space;
(c) matching at said central control system the space offer from step (a) with the space request from step (b) according to predetermined criteria;
(d) transmitting a message from said central control system to said transferee directing said transferee to said parking space;
(e) transmitting a message from said central control system to said transferor directing said transferor to continue occupying said parking space until the arrival of said transferee; and
(f) interchanging said transferor with said transferee in said parking space;
whereby said parking space will be transferred from said transferor to said transferee; and
whereby a driver can efficiently find and occupy a parking space in a guaranteed fashion.

2. The method of claim 1, wherein said parking space is an on-street parking space.

3. The method of claim 1, wherein one or both of the vehicle operators send and receive said messages of steps (a), (b), (d) and (e) via mobile cellular telephones.

4. The method of claim 1, wherein one or both of the vehicle operators send and receive said messages of steps (a), (b), (d) and (e) via onboard navigation systems.

5. The method of claim 1, wherein one or both of the vehicle operators send and receive said messages of steps (a), (b), (d) and (e) via handheld computing devices.

6. The method of claim 1, wherein said wireless communications network employed by one or both of said vehicles is a satellite based digital communications network.

7. The method of claim 1, wherein said messages of steps (a) and (b) contain the geographic locations of the respective vehicles as reported by onboard position sensors, such as GPS transceivers.

8. The method of claim 1, wherein said messages of steps (a) and (b) contain descriptions of physical attributes of the respective vehicles, such as vehicle length, width, make, model and year.

9. The method of claim 1, wherein said step (c) comprises determining a match according to the relative proximity of the two vehicles.

10. The method of claim 1, wherein said step (c) comprises determining a match according to physical attributes of the two vehicles, such as vehicle length.

11. The method of claim 1, wherein said step (c) comprises determining a match according to a real-time price auction.

12. The method of claim 1, wherein said message of step (d) includes street-level driving instructions that direct said transferee to said parking space.

13. The method of claim 1, wherein at least one of the participating vehicles sends a message to said central control system, after completion of step (f), signaling the transfer was successfully completed.

14. The method of claim 1, wherein a usage account associated with at least one of the participating vehicles is debited or credited, after completion of step (f), to reflect the successful completion of the parking space transfer.

15. A parking space detection and transfer system, comprising:
(a) a mobile user unit for sending formatted messages between a vehicle operator and a central control system, said mobile user unit comprising: a non-volatile memory for storing vehicle attributes such as a unique vehicle identification code and vehicle geometry, a position sensor capable of determining the geographic location of said mobile user unit, a wireless network interface for transmitting messages between said mobile user unit and said central control system, and a user interface configured for accepting input from said vehicle operator for the purpose of signaling that said operator is offering for transfer a currently occupied parking space or that said operator is requesting a parking space, where said user interface is also configured to present to said operator instructional and informational messages concerning the transfer of said parking space;
(b) a wireless mobile communications network for carrying messages between said mobile user unit and said central control system; and
(c) a central control system for matching the parking space offer with the parking space request and for sending instructional and informational messages concerning the transfer of said parking space; said central control system comprising: a memory configured to store a plurality of said parking space offers, a memory configured to store a plurality of said parking space requests, a data processor configured to control the storage of said parking space offers in said memory and to control the storage of said parking space requests in said memory, where the data processor is further configured to match parking space requests with parking space offers according to predetermined criteria and further configured to exchange formatted instructional and informational messages with said mobile user units, and a wireless network interface for transmitting messages between said central control system and said mobile user unit.

16. A system according to claim 14, wherein said mobile user unit is a general purpose wireless telephone, non-exclusively configured through special purpose software for use in said parking space detection and transfer system.

17. A system according to claim 14, wherein said mobile user unit is a general purpose vehicular onboard navigation system, non-exclusively configured through special purpose software for use in said parking space detection and transfer system.

18. A system according to claim 14, wherein said central control system is connected to said wireless mobile communications network via the Internet.

19. A system according to claim 14, wherein said central control system comprises a geographic information system (GIS) for calculating the distance between the vehicle offering said parking space and the vehicle requesting a parking space, and for calculating street-level driving instructions that will direct the vehicle requesting a parking space to said offered parking space.

20. A system according to claim 14, wherein said central control system comprises a database for storing a record of each completed parking space transfer for the purpose of debiting and crediting subscriber accounts associated with the vehicles that participate in the parking space transfer.
